(19) United States
(12) Patent Application Publication
(10) Pub. No.: US 2010/0044571 A1
(43) Pub. Date: Feb. 25, 2010

(54) METHOD FOR DETERMINING THE THREE-DIMENSIONAL POSITION OF A SCINTILLATION EVENT

(75) Inventors: Robert S. Miyaoka, Shoreline, WA (US); Thomas K. Lewellen, Port Ludlow, WA (US); Tao Ling, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: UNIVERSITY OF WASHINGTON, Seattle, WA (US)

(21) Appl. No.: 12/544,174

(22) Filed: Aug. 19, 2009

Related U.S. Application Data
(60) Provisional application No. 61/090,156, filed on Aug. 19, 2008.

(51) Int. Cl. G01T 1/20

(52) U.S. Cl. 250/362

(57) ABSTRACT

A method is provided for determining the three-dimensional position of an interaction location within a scintillating crystal at which an high-energy photon produces a plurality of scintillation photons. The method includes the use of a sensor-on-entrance-surface photodetector device to determine a distribution pattern of the scintillation photons in the crystal.

### CROSS-REFERENCE TO RELATED APPLICATION

This application claims the benefit of U.S. Application No. 61/090156, filed on Aug. 19, 2008, which is expressly incorporated herein in its entirety.

### STATEMENT OF GOVERNMENT LICENSE RIGHTS

This invention was made with Government support under federal grants NIBIB EB001563 and EB002117, both awarded by the National Institutes of Health. The Government has certain rights in the invention.

### BACKGROUND

Positron emission tomography (PET) imaging has revolutionized imaging of internal biological regions by providing functional images of a patient or other region of interest. PET is a nuclear medicine medical imaging technique that produces a three-dimensional image or map of functional processes in the body, e.g., imaging that illuminates chemical and metabolic activity in the patient. The role of PET imaging in oncology research and patient care, in particular, is growing due to the ability of PET to add unique functional information to that obtained by conventional anatomical imaging modalities, for example CT.PET scanning is an emissive technique wherein a short-lived radioactive tracer isotope, chemically combined with a metabolically active molecule such as a sugar, is injected into the subject. The metabolically active molecule becomes concentrated in the tissues of interest, concentrating the tracer isotope in regions of such activity. After injecting the isotope, the patient is placed on the scanner. As the injected isotope decays it emits a positron that annihilates with an electron, producing a pair of gamma photons or high-energy photons (e.g., 511 keV) that travel in opposite directions. The high-energy photons are herein referred to as annihilation photons. In general terms, the emitted photons are detected when they reach a scintillator material in the scanning device, creating a burst of light that is typically detected by a photosensor, such as a photomultiplier tube, avalanche photodiode, etc.

The detection technique relies on the coincident detection of the pair of photons to identify valid signals. Photons that are not detected within a few nanoseconds of each other are ignored. A straight line through the locations in the detector where the coincident photons are detected is called the line of response (“LOR”). The location of the positron emission is therefore known to lie somewhere along the LOR. The PET scanner uses the pair detection events and the LORs to map the density of the tracer isotope within the body. In a typical system, the images are generated along parallel slices separated by about 5 mm and the images are then combined to produce a three-dimensional image or model of the region of interest. The resulting map shows where the tracer isotope has become concentrated, identifying regions of metabolic activity in the body.

Discrete crystal detector modules have traditionally been used to achieve high spatial resolution for small animal PET scanners. However, cost goes up quickly as crystal cross-section gets smaller. The present inventors have previously investigated a continuous miniature crystal element (cMiCE) detector as a lower cost alternative to high-resolution discrete crystal designs for PET detectors.

In traditional PET detectors, the photosensors are positioned on the back side of the cystal, i.e., the side opposite the entrance surface of the crystal, or distal to the object being imaged. Using the traditional design detector configuration, the best depth-of-interaction (DOI) estimation for the position of an annihilation photon interacting to produce scintillation photons within the detector occurs in the back section of the crystal. However, because of the exponential interaction probability, most interactions occur in the front section of the crystal.

The present inventors have described a method for calculating depth of interaction information for an apparatus comprising photosensors positioned on the back side of a crystal in Ling, T. et al., “Depth of interaction decoding of a continuous crystal detector module,” Phys. Med. Biol. 52:2213-2228, 2207, the disclosure of which is hereby incorporated by reference in its entirety.

Previously, relatively thin (e.g., 3-4 mm) crystals were used to minimize DOI effects during detection. However, thin crystals may not capture all annihilation photons, as some may pass entirely through the crystal without scintillation. Thicker crystals (e.g., 15 mm) can be used to capture more annihilation photons, but increased thickness leads to inaccuracies in positioning data unless the DOI of a scintillation event is known.

High energy photons occur in other contexts and applications. For example photon-emitting radioisotopes such as Technetium-99 m emit photons having an energy of about 140 keV. Such radioisotopes have found use in nuclear medicine, for example as a radioactive tracer.

What is desired, therefore, is a method for more accurately detecting the three-dimensional location of high-energy photon scintillation events within a scintillating crystal, and in particular to improved DOI determination.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a method for estimating the three-dimensional position of a scintillation interaction in a monolithic crystal is provided. The method comprises the steps of: (a) providing a detector comprising a monolithic scintillating crystal having an entrance face, and an array of photosensors disposed on the entrance face of the crystal; (b) directing a gamma photon towards the entrance face of the crystal such that the gamma photon passes through the array of photosensors prior to entering the crystal through the entrance face and interacts with the crystal to produce a plurality of scintillation photons at a three-dimensional interaction location within the crystal; (c) detecting the scintillation photons with the array of photosensors to provide a distribution pattern indicating the number of scintillation photons received by individual photosensors in the array of photosensors; and (d) estimating the three-dimensional interaction location within the crystal using the distribution pattern of the detected scintillation photons on the array of photosensors.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatic side view of a prior art monolithic crystal annihilation photon detector with sensors disposed on the back face, as is known in the prior art;

FIG. 2 is a representative probability density function (PDF) defined as a histogram of detected events sorted by the amount of light received by a selected photosensor for the detector illustrated in FIG. 1, and indicating corresponding PDFs for selected depth of interaction (DOI) regions of the crystal;

FIG. 3 is a diagrammatic side view of an annihilation photon detector useful in the embodiments described herein having a sensor-on-entrance-surface configuration;

FIG. 4 is a representative light histogram PDF for a selected photosensor of the device illustrated in FIG. 3, and indicating corresponding PDFs for selected DOI regions of the crystal;

FIG. 5A shows PDFs illustrating sample depth separation results obtained using a maximum likelihood clustering method from simulated data for a conventional detector shown in FIG. 1;

FIG. 5B shows PDFs illustrating sample depth separation results obtained using a maximum likelihood clustering method from simulated data for the SES detector shown in FIG. 3;

FIG. 6A shows DOI errors of statistical based positioning for an eight by eight photosensor array geometry for a detector of the type shown in FIG. 1;

FIG. 6B shows DOI errors of statistical based positioning for an eight by eight photosensor array geometry for a detector of the type shown in FIG. 3; and

FIG. 7 illustrates a 12 by 12 array of photosensors in a photosensor array with an overlayed diagrammatic row-column summing scheme for reading the devices of the array.

### DETAILED DESCRIPTION

A method is provided for determining the three-dimensional position of an interaction location within a scintillating crystal at which an annihilation or other high-energy photon produces a burst of scintillation photons. The method includes the use of a detector comprising a monolithic scintillation crystal having an array of photosensors on the entrance surface of the crystal. The distribution pattern of the light collected by the array of photosensors is used to calculate the three-dimensional location of the scintillation event within the crystal.

Scintillation is a luminescence process wherein light of a characteristic spectrum is emitted following the absorption of radiation such as a high-energy photon. Certain crystals are known to produce a burst of “scintillation” (i.e., lower-energy) photons when a gamma photon or “annihilation” (i.e., higher-energy) photons is absorbed, hereinafter referred to as a scintillation event, or simply an event. For example, in PET a typical scintillation event will produces tens of thousands of scintillation photons from a single annihilation photon. Representative scintillating crystals include cerium-doped Lu₂SiO₅ (LSO), lutetium fine silicate (LFS), and cerium-doped lutetium yttrium orthosilicate (LYSO).

In the devices used in the methods disclosed herein, photosensors are disposed on the proximal (entrance) surface of the scintillating crystal to the annihilation photon source, an arrangement referred to herein as a sensor-on-entrance-surface (SES) design. The SES design typically relies on solid state photosensors, such as silicon photomultipliers (SiPM) and avalanche photodiodes (APD), including micro-pixel avalanche photodiodes (MAPD). These photosensors have relatively low attenuation to 511 keV photons, making them suitable for placement on the front surface of PET detectors. In addition, these photosensors can be housed in very compact packaging to limit any packing fraction issues associated with a full-detector system. An added benefit is that both of these types of sensors can be operated in high magnetic fields, which enables the possibility of PET/MR multimodality imaging using the proposed design.

In exemplary embodiments described herein, the detector for performing the disclosed method is an SES PET detector using a 2D array of SiPMs, although it will be appreciated that the method can be applied to other systems than PET scanning, and other photosensors can be used besides SiPMs, including for example APDs and MAPDs.

SiPMs are a relatively new type of photodiode with Geiger mode operation. SiPM devices provide high gain (˜10⁵) and optimal timing characteristics for coincidence imaging, an important consideration for PET scanning.

SES Design

FIG. 1 schematically illustrates a side view of a prior art design for a monolithic crystal PET detector device 100, with photosensors 105 disposed opposite an entrance surface 107 of a scintillating crystal 110. The crystal 110 will typically be approximately a rectangular solid with the photosensors 105 disposed in a two-dimensional array on the crystal surface. An annihilation photon 120 is shown impinging on the entrance surface 107 of the crystal 110. A photosensor entrance window 115 is provided between the photosensors 105 and the crystal 110. The annihilation photon 120 enters the crystal 110 and typically will eventually interact with an electron in the crystal 110, to produce a burst of scintillation photons (not shown) at some three-dimensional location within the crystal 110. As discussed below, the interaction may be a photo-electric absorption event, or a Compton-scatter event.

Consider now that a large number of gamma photons 120 may be directed to a particular location on the entrance surface 107 of the crystal 110. In particular, to calibrate the detector 100 a large number of gamma photons 120 may be directed perpendicular to the entrance surface 107 at a particular x-y position defined by the two-dimensional entrance surface 107. The gamma photons 120 will travel varying distances (i.e., in the z-direction) within the crystal 110 before a scintillation event occurs. It will be appreciated that the amount of light received or collected by each individual photosensor 105 will depend on the particular location of the scintillation event.

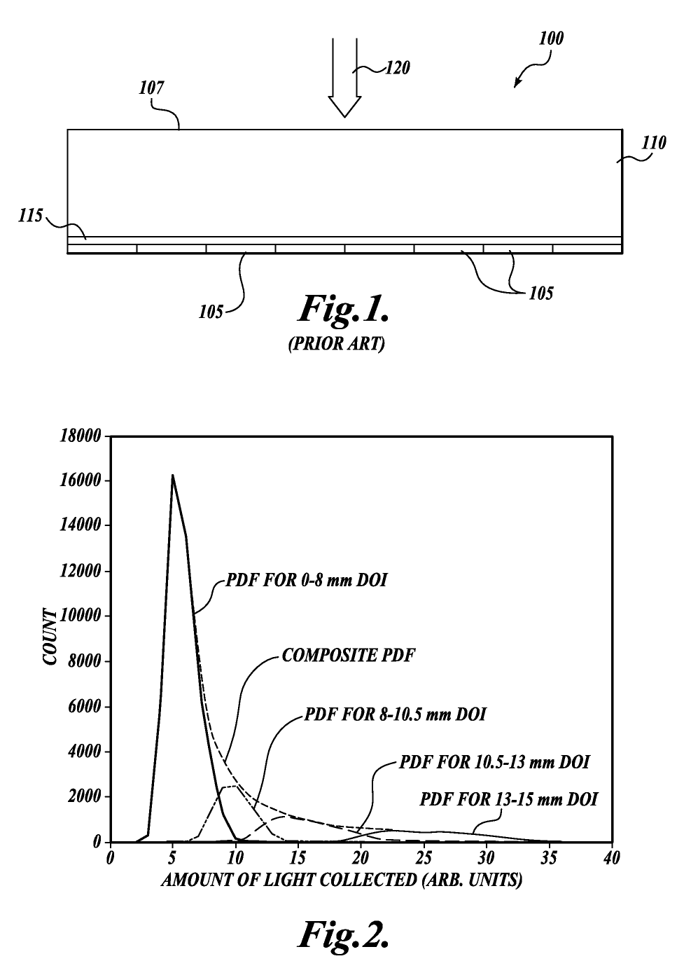

FIG. 2 illustrates a light distribution probability density function (PDF) for a particular photosensor 105 (e.g., the photosensor disposed directly under the photon flux gamma photons 120), comprising a histogram of the number or count of scintillation events as a function of the amount of light (e.g., number of scintillation photons) collected by the selected photosensor 105. The composite PDF is from the total number of events detected by the selected sensor 105, as a function of the amount of scintillation light collected.

It will be appreciated that the composite PDF may be decomposed into the PDFs for events occurring at various depths of interaction (DOI) within the crystal 110. For example, the linear attenuation coefficient of the scintillating crystal (e.g., LYSO) may be used to estimate the number of scintillation interactions at each depth.

In the present example the crystal 110 is 15 mm thick. FIG. 2 illustrates PDFs for four depth regions measured from the entrance surface 107: (i) 0-8 mm; (ii) 8-10.5 mm; (iii) 10.5-13 mm; and (iv) 13-15 mm. As can be seen for the traditional device configuration illustrated in FIG. 1, the peak of the PDF varies more significantly for scintillation events occurring at depths between 8-15 mm than for events occurring at depths between 0-8 mm. In the DOI estimation method disclosed herein the DOI estimate is more accurate for regions where the amount of light collected is varying rapidly with depth. Therefore, ideally, most of the events would take place within depths 8-15 mm. However, because of the exponential interaction probability, a significant majority of the interactions occur within the first 8 mm of the crystal (over 50% of the initial interactions occur in the first 5.5 mm) where DOI discrimination is the poorest.

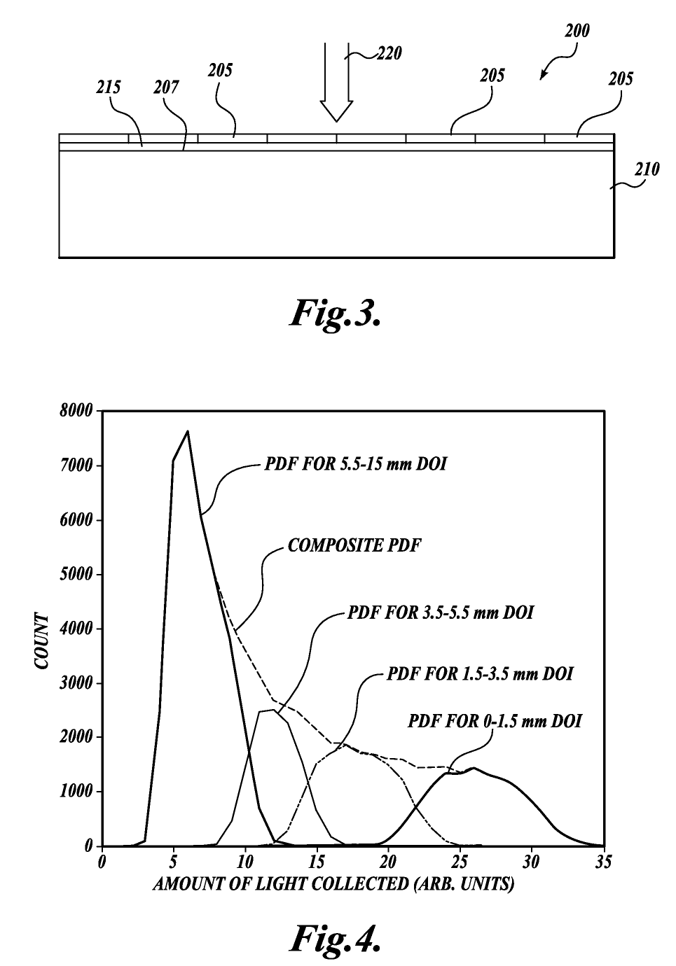

Referring to FIG. 3, a side view of an SES detector 200 useful in the disclosed methods is illustrated, wherein the photosensors 205 are disposed on the entrance surface 207 of the crystal 210. The annihilation photons 220, therefore, pass through the sensors 205 prior to entering the crystal 210. However, as noted above, many photosensors, including SiPMs and APDs, do not significantly attenuate gamma photons. In the illustrated embodiment, an optional optical window 215 provides an optical interface between the photosensors 205 and the scintillating crystal 210.

FIG. 4 shows the composite PDF for a particular photosensor 205 comprising a histogram of the number of detected events as a function of the amount of light collected by the photosensor 205. The composite PDF is decomposed to show the PDF for: (i) 5.5-15 mm DOI; (ii) 3.5-5.5 mm DOI; (iii) 1.5-3.5 mm DOI; and (iv) 0-1.5 mm DOI.

Because the majority of the scintillation events occur within the region of the crystal nearest the entrance surface, e.g., within the first 0-5.5 mm, the amount of the light collected by the SES photosensors 205 varies more rapidly within the 0-5.5 mm region where most interactions occur. Therefore, the SES design and the methods disclosed herein provide improved DOI positioning compared to traditional devices and methods.

Statistics-Based Positioning (SBP) Algorithm with DOI Information

A method for determining the three-dimensional position of the interaction location of the scintillation events within the scintillating crystal will now be described in more detail. In one embodiment, the three-dimensional position of the interaction location is estimated by the following theory and method.

First, it is assumed that the distributions of observing signal outputs M=M₁, M₂ . . . Mₙ for scintillation position x, are independent normal distributions with mean, μ(x), and standard deviation σ(x).

The likelihood function for making any single observation mi from distribution Mᵢ given x is described in Equation 1:

$$L [ {m}_{i} \vert x ] = {\prod }_{i = 1}^{n} \frac{1}{{σ}_{i} ( x ) \sqrt{2 π}} exp ( - \frac{{( {m}_{i} - {μ}_{i} ( x ) )}^{2}}{2 {σ}_{i}^{2} ( x )} ) \qquad ( 1 )$$

The maximum likelihood estimator of the event position x is described in Equation 2:

$$\hat{x} = {argmin}_{x} [ {\sum }_{i} \frac{{( {m}_{i} - {μ}_{i} ( x ) )}^{2}}{2 {σ}_{i}^{2} ( x )} + ln ( {σ}_{i} ( x ) ) ] \qquad ( 2 )$$

The SBP method requires that the light response function versus interaction location be characterized for the detector, where the light response function can be described by the mean number of light photons detected by a photosensor as a function of interaction position and the variance of the mean. Two SBP look-up tables (LUTs) corresponding to the mean and variance of the light probability density function (PDF) versus x,y position are created during the characterization process.

To extend the SBP method for 3D positioning (i.e., DOI), a maximum likelihood (ML) clustering method is used for extracting DOI information from a monolithic crystal. The DOI separation technique divides the calibration data into different DOI regions, such as the DOI regions shown in FIG. 4. LUTs are then created for each DOI region. The full set of DOI LUTs allows the use of 3D ML positioning within the detector 200.

In an exemplary embodiment, the ML clustering technique is used to extract up to 7 DOI regions from a 15 mm thick scintillation crystal 210, such as the cMiCE LYSO crystal.

The SBP method continues by generating a polynomial fit (e.g., a third-order polynomial fit) applied to the mean and variance respectively for each x,y position on the detector for which training data has been obtained. Then a 15-depth DOI LUT is generated from the fit result.

The algorithm uses the fact that the light distribution pattern varies continuously and smoothly with DOI so scintillation events occurring in similar DOI regions of the crystal will produce similar light distribution patterns.

An exemplary 7-depth DOI LUT generation method, as useful in the methods disclosed herein, can be separated into five basic steps.

Step 1. Training data is obtained by directing a source of gamma photons at the entrance surface 207, perpendicular to the surface, at a known x,y position. For the training data at each position, the photosensor channel N receiving the maximum amount of light is identified. The light histogram data for that photosensor or channel is separated into seven initial groups according to their pulse height in photosensor channel N. For example, group 1 consists of events within the highest one-seventh of the PDF histogram, which correspond to interactions occurring closest to the photosensors in the crystal, and group 7 consists of events comprising the lowest one-seventh of the PDF histogram, which correspond to interactions occurring in the crystal furthest from the photosensors.

Step 2. For each set of data (i.e., groups 1 through 7), the mean μ(j)ᵢ and standard deviation σ(j)ᵢ are generated, where i is the number of the photosensor channel and j is the group number.

Step 3. For each detected event, the likelihood ratios between different groups are calculated and the event is placed in the most likely depth region. After all data has been sorted, one or more iterations of Steps 2 and 3 are performed until a stable separation is reached.

Step 4. After a stable separation is reached, the final mean and standard deviation are generated where they represent the light-response LUTs for DOI regions 1 through 7, respectively.

Step 5. For each x,y position, a third-order polynomial fit is applied to the seven DOI means and standard deviations, respectively. A 15-depth DOI LUT is generated from the fitting results.

The theory behind the initial grouping in Step 1 is that the signal from channel N correlates with DOI. Based upon solid angle considerations, interactions near the photosensor window will have a larger amount of light collected by the photosensor channel directly under the interaction location than interactions further from the photosensor. The pattern of the annihilation photons on the detector array, along with the training and calibration data, leads to the determination of the depth of interaction within the crystal where the scintillation photons were produced.

In an exemplary embodiment, the x, y and z LUTs are treated as a single 3D LUT and the location searching for the event is conducted on a 3D grid. However, it is contemplated that for computational efficiency an interative process may alternatively be used wherein a preliminary 2D search in x-y space is first conducted to determine a preliminary estimate of the location relative to planes parallel to the entrance surface, followed by a search in the z (depth) direction, and fally refining the 2D search in x-y space. Other searching schemas may be used, as will be apparent to persons of skill in the art.

The Example below describes an exemplary procedure for simulating calibrating and testing devices useful in the methods disclosed herein, as well as conventional devices (i.e., non-SES devices).

In one embodiment, energy thresholding is used to discriminate between photoelectrically-absorbed photons in the detector and Compton-scattered photons in the detector. It is desirable to utilize events that have only experienced a single photoelectric interaction in the detector when calibrating the detector. Compton-scattered photons only deposit a portion of their energy. Therefore they can be filtered out using a lower energy threshold requirement. Traditionally, an energy window is set for an entire device, filtering out all data outside a range centered around the energy peak of the photons of interest. For example, for PET detectors operating at 511 keV annihilation photons, a window of ±20% of the peak energy is accepted as the detected, non-Compton-scattered photons.

Two energy-thresholding methods are provided. First, the energy window (e.g., ±20% of the peak energy) is adaptively adjusted according to the energy resolution of the calibration data for a specific point on the surface of the photosensor array. Particularly, DOI effects near the edges of individual photosensors result in broadened energy peaks. Therefore, a wider energy window for data acquired at the edges of devices leads to more accurate characterization of the depth-dependent light distribution than if the (relatively) narrow energy window from the bulk of the device (i.e., not at the edges) is used.

The second energy-thresholding method provided determines a local minimum in the “Compton valley” (i.e., the range of energies between the maximum energy deposited by a single Compton interaction and a photoelectric absorption) of the acquired energy spectrum. Thus, the spatially-dependent lower-energy threshold is set by the minimum point within the Compton valley. The principle behind this technique is that all interactions above the local minimum of the Compton valley should be from photons that have been photoelectrically absorbed. This technique does not depend upon the energy resolution of the detector at a given calibration location and is relatively immune to the depth of interaction light collection effects associated with the edges of a detector. The upper energy window is selected to effectively allow all photoelectrically absorbed events to be accepted.

In one embodiment, multiple channels from the photosensor array are used to determine the x,y location of the maximum signal. (In the present application the x,y coordinates refer to location coordinates in planes parallel to the entrance surface of the crystal, and z is used to refer to the location coordinate in the direction perpendicular to the entrance surface of the crystal.) In the methods described herein, the photosensor(s) having the maximum signal are used to perform an initial x,y localization of the event in the crystal and also to create the initial PDF plot (e.g., FIG. 4). Typically, the scintillation event will occur such that the bulk of the detected scintillation photons will be detected by a single photosensor, in which case that photosensor is used to determine the initial depth-dependent PDF and the preliminary x,y localization of the event. However, if the event occurs near the margins of a plurality of photosensors, two or more photosensors can be used to determine the PDF. Additionally, if row-column summing of the x- and y-channels is utilized, multiple x and multiple y channels can also register a maximum signal and would be used to calculate the PDF and initial positioning of the event.

The following example is for the purpose of illustrating, and not limiting, the disclosed invention.

### EXAMPLE

Simulation tools were utilized to investigate different detector designs. To summarize, a Monte Carlo simulator, such as DETECT2000, is used to determine the probability that a light photon generated at a specific (X, Y, Z) position in the crystal is detected by a specific photosensor. Another Monte Carlo simulator, for example GEANT is used to track the gamma interactions (both Compton and photoelectric) within the crystal. For each interaction, the number of light photons produced by the scintillator crystal is determined. That number is adjusted for the non-proportionality of LSO according to known characteristics. Poisson noise is then added to the number of light photons produced. Using the detection probabilities determined from the DETECT2000 simulations, the number of light photons striking each photosensor is determined. The number of light photons is then adjusted by the photon detection efficiency of the photosensor. Poisson noise is then added to the number of detected light photons. The number of light photons detected by each sensor for each interaction is summed for the final light distribution for a given event.

For the DETECT2000 simulations, the large area surface opposite the photosensors was modeled as being painted with white reflective paint (reflectivity coefficient of 0.98); the sides were modeled as being painted with black paint (reflectivity coefficient of 0.10). The scintillator material was modeled as producing 22,000 light photons per MeV. It was also modeled as having an index of refraction of 1.82. The index of refraction for the optical glue and the entrance window of the photosensor were 1.44 and 1.47, respectively. The photon detection efficiency (PDE) was set to 22.5%. This is similar to a PMT and within the range of PDE reported by different manufacturers of solid-state photosensors. In general, APDs have much better quantum efficiencies, while the range of PDEs reported for SiPM devices varies between 4% up to ˜50% at a wavelength of 480 nm.

Using the simulation implementation and parameter values as listed, an average energy resolution of 14% for the conventional design and 15.4% for the SES design was measured.

Intrinsic Spatial Resolution Testing

Three different photosensor array geometries were evaluated: 8 by 8 with 5.8 mm by 5.8 mm array elements with 6.08 mm center-to-center spacing; 12 by 12 with 3.8 mm by 3.8 mm pixels and 4.08 mm center-to-center spacing; and 16 by 16 with 2.8 mm by 2.8 mm pixels with 3.08 mm center-to-center spacing. The crystal was modeled as a 48.8 mm by 48.8 mm by 15 mm slab of LYSO for the 8 by 8 sensor array and 49.2 mm by 49.2 mm by 15 mm for the 12 by 12 array; and 49.6 mm by 49.6 mm by 15 mm for the 16 by 16 array.

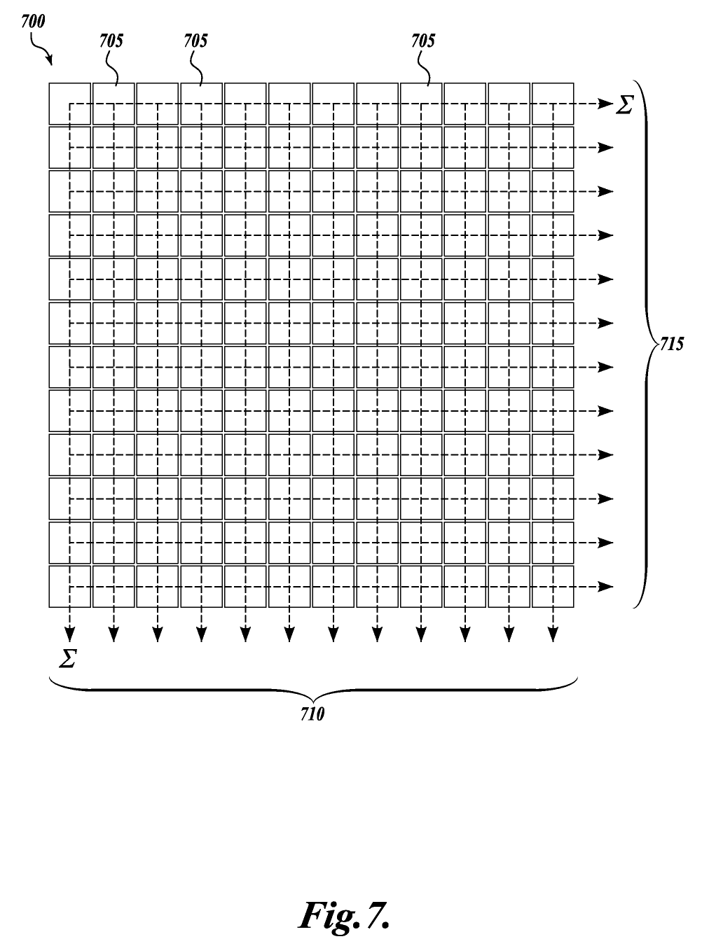

For the 8 by 8 array configuration the intrinsic spatial resolution characteristics were determined using the SES design and also for the conventional placement of the photosensors on the exit surface of the crystal. For the 12 by 12 and 16 by 16 pixel arrays, the intrinsic spatial resolution was determined using row-column summing (i.e., 24 and 32 channels). The 12 by 12 array configuration with row-column summing is illustrated in FIG. 7, wherein the array 700 includes a plurality of photosensors 705, each electrically readable by one of a plurality of columns 710 and rows 715.

The 15-depth DOI LUTs were built (as described above) from photon fluxes with a diameter of 0.6 mm FWHM perpendicular to the face of the detector. The spacing between photon fluxes was 1.52 mm, 1.025 mm, and 1.55 mm in X and Y for the 8-by-8, 12-by-12 and 16-by-16 arrays, respectively. The LUT binning was 0.256 mm for the 12-by-12 photosensor array and 0.38 mm for the 8-by-8 and 16-by-16 arrays. Photon fluxes of normal incidence were used to train and test the x,y and DOI positioning of the detector. The events were simulated as being a point flux for testing. Twenty thousand events were used for training. Ten thousand events were used for testing. The effect of Compton scatter in the crystal was included for both training and test data. The DOI resolution represents the error in the calculated DOI estimate versus the known first interaction point. The X and Y resolution was based upon the measured FWHM of the cumulative point spread function of all DOI layers summed together.

Results

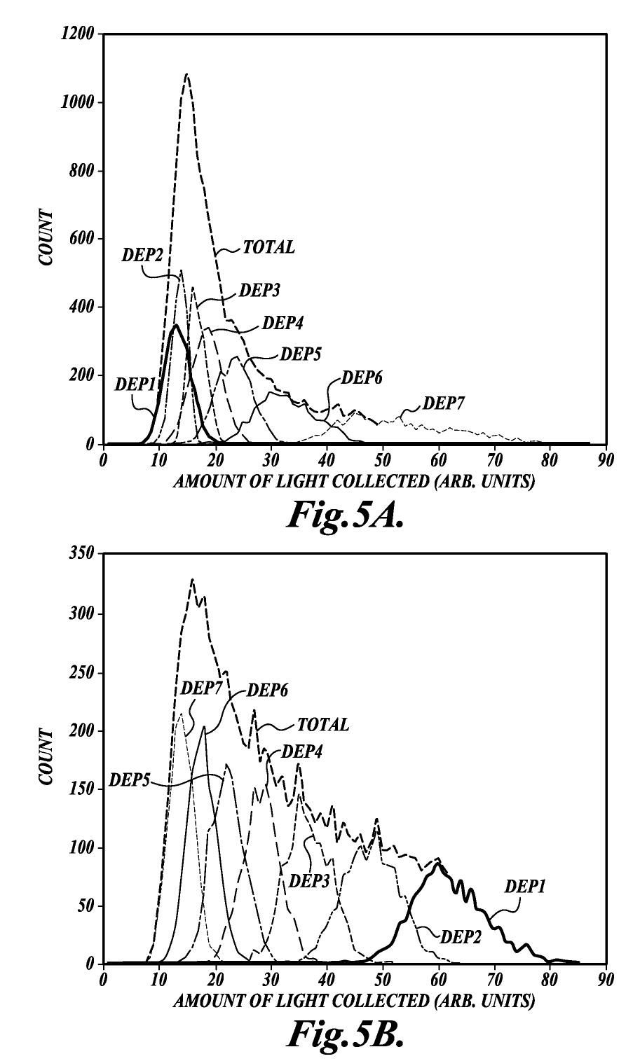

Sample depth separation results are graphically illustrated as acquired from simulated data for both conventional (FIG. 5A) placement of the sensor array on the backside of the monolithic crystal (as shown in FIG. 1) and for the SES design (FIG. 5B) with the sensor array on the entrance surface of the crystal (as shown in FIG. 3). In each of FIGS. 5A and 5B the total response of the detector (labeled as TOTAL) is graphed, as are individual PDFs (labeled as DEP1-DEP7, wherein DEPI is closest to the proximal surface (e.g., 107 and 207) of the crystal and DEP 7 is the furthest away from the proximal surface. Note that for the conventional design (FIG. 5A), there is significant overlap of the light PDFs (DEP1-DEP7) for depth regions 1-4, where a majority of events occur. Only regions 6 and 7 (DEP6 and DEP7) show good separation between the light PDFs. Conversely, results from the SES design of the provided method (FIG. 5B) show very good separation of the PDFs (DEP1-DEP7) for depth regions 1-4 (DEP1-DEP4), where most of the interactions are occurring. Increased separation between DOI regions leads to more accurate prediction of the DOI of a measured event.

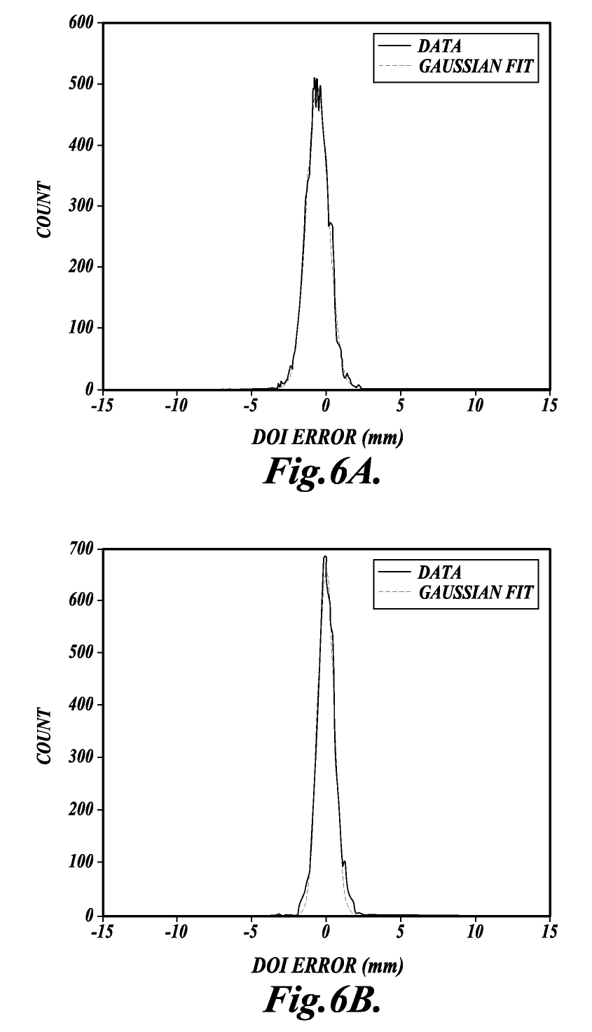

Representative distributions of DOI positioning error are graphed, with a Gaussian fit, where the average FWHM is 2.28 mm for the conventional design (FIG. 6A) and 1.83 mm for the SES design (FIG. 6B). The deleterious effects of Compton scattering in the detector have been removed from FIGS. 6A and 6B.

The results for FWHM (full width at half maximum) of normally incident photons for the 12×12 and 16×16 sensor array geometries were determined using row-column summing of the pixels. The spacing between photon fluxes is 1.025 mm for the 12×12 array detector and 1.55 mm for the 16×16 array detector. The x,y intrinsic spatial resolution performance is similar for both array geometries: 0.67 mm FWHM for the 12×12 array and 0.64 mm FWHM for the 16×16 array. The DOI positioning accuracy was also similar, 1.52 mm FWHM and 1.45 mm FWHM for the 12×12 and 16×16 photosensor arrays, respectively.

Table 1 summarizes the intrinsic spatial resolution positioning results for the various detector configurations. The results are the average intrinsic spatial resolutions for the detector excluding the edge of the crystal. The first points were 1.52 mm, 1.025 mm and 1.55 mm from the edge of the crystal for the 8×8, 12×12 and 16×16 array configurations, respectively. Because of the symmetry of the detector, the results for one eighth of the detector are representative of the whole detector.

TABLE 1
Spatial resolution and positioning bias for different designs

| Design | Dimension | Bias (mm) | FWHM (mm) |
|---|---|---|---|
| 8 × 8 array | X, Y | 0.01 +/− 0.05 | 1.15 +/− 0.16 |
| (conventional) | direction | | |
| | DOI | −0.67 +/− 0.10 | 2.28 +/− 0.15 |
| 8 × 8 array | X, Y | 0.00 +/− 0.03 | 0.88 +/− 0.12 |
| (SES) | direction | | |
| | DOI | 0.16 +/− 0.16 | 1.83 +/− 0.24 |
| 12 × 12 array | X, Y | 0.01 +/− 0.04 | 0.67 +/− 0.12 |
| (SES, row- | direction | | |
| column) | | | |
| | DOI | −0.05 +/− 0.16 | 1.52 +/− 0.24 |
| 16 × 16 array | X, Y | 0.00 +/− 0.01 | 0.64 +/− 0.07 |
| (SES, row- | direction | | |
| column) | | | |
| | DOI | −0.03 +/− 0.11 | 1.45 +/− 0.10 |

For the 8×8 photosensor array, the SES design provided an improvement of ˜24% in the X, Y intrinsic spatial resolution and ˜20% in DOI positioning performance. Further, for DOI positioning, the SES design was significantly less biased. The results illustrate the improvement of the provided method, wherein a majority of the photon interactions occurring in a region of the crystal where the light distribution PDF is varying most rapidly (i.e., where the DOI positioning resolution is the most accurate).

Further improvements in both X,Y and DOI positioning performance were obtained by using smaller pixel elements. These pixel sizes are more reflective of the largest SiPM devices currently being offered by manufacturers and are also becoming available in 2D array packages. Even when using row-column summing (which significantly reduces the number of signals channels that need to be collected) the positioning performance was better for the 12×12 and 16×16 array devices compared to the 8×8 photosensor array detector.

Thus, two-dimensional SiPM arrays with small dead areas between pixels provide improved results compared to devices having large dead areas between pixels.

While illustrative embodiments have been illustrated and described, it will be appreciated that various changes can be made therein without departing from the spirit and scope of the invention.

1. A method for estimating the three-dimensional position of a scintillation interaction in a monolithic crystal comprising:
(a) providing a detector comprising a monolithic scintillating crystal having an entrance face, and an array of photosensors disposed on the entrance face of the crystal;
(b) directing a gamma photon towards the entrance face of the crystal such that the gamma photon passes through the array of photosensors prior to entering the crystal through the entrance face and interacts with the crystal to produce a plurality of scintillation photons at a three-dimensional interaction location within the crystal;
(c) detecting the scintillation photons with the array of photosensors to provide a distribution pattern indicating the number of scintillation photons received by individual photosensors in the array of photosensors; and
(d) estimating the three-dimensional interaction location within the crystal using the distribution pattern of the detected scintillation photons on the array of photosensors.

2. The method of claim 1, wherein step of estimating the three-dimensional interaction location comprises using a plurality of look-up tables that characterize a depth of interaction in the crystal based on the distribution pattern detected by the array of photosensors.

3. The method of claim 2, wherein the plurality of look-up tables comprise a look-up table for a mean response of the array of photosensors to the scintillation photons and a look-up table for a variance of the response of the array of photosensors to the scintillation photons.

4. The method of claim 1, wherein the array of photosensors comprises a grid having dimensions selected from the group consisting of 8-by-8 photosensors, 12-by-12 photosensors, and 16-by-16 photosensors.

5. The method of claim 1, wherein the photosensor array comprises an array of photosensors selected from the group consisting of avalanche photodiodes and silicon photomultipliers.

6. The method of claim 1, wherein the scintillating crystal is selected from the group consisting of cerium-doped Lu₂SiO₅, lutetium fine silicate, and cerium-doped lutetium yttrium orthosilicate.

7. The method of claim 1, wherein the array of photosensors are read using row-column summing.

8. The method of claim 1, wherein an optical window is disposed intermediate the front face of the crystal and the array of photosensors.

9. The method of claim 1, wherein the annihilation photons have an energy of about 511 keV.

10. The method of claim 1, wherein the annihilation photons are generated during positron emission tomography.

11. A method for estimating in three dimensions the location of photoelectric absorption events in a transparent crystal, the method comprising:
providing a transparent scintillation crystal having an entrance surface adapted to receive gamma photons;
providing an array of photoelectric sensors on the entrance surface of the crystal;
directing a plurality of gamma photons through the array of photoelectric sensors and into the crystal such that a plurality of photoelectric absorption events occur in the crystal;
for each of the photoelectric absorption events, detecting the low-energy photons generated by the event with the array of photosensors;
for each of the photoelectric absorption events, analyzing the spatial and number of photon distribution detected by the array of photosensors;
using the spatial distribution and of photon distribution to calculate the three dimensional position of each of the photoelectric absorption events within the crystal.

12. The method of claim 11, wherein the array of photosensors comprises a grid having dimensions selected from the group consisting of 8-by-8 photosensors, 12-by-12 photosensors, and 16-by-16 photosensors.

13. The method of claim 11, wherein the photosensor array comprises an array of photosensors selected from the group consisting of avalanche photodiodes and silicon photomultipliers.

14. The method of claim 11, wherein the scintillating crystal is selected from the group consisting of cerium-doped Lu₂SiO₅, lutetium fine silicate, and cerium-doped lutetium yttrium orthosilicate.

15. The method of claim 11, wherein the array of photosensors are read using row-column summing.

16. The method of claim 11, wherein an optical window is disposed intermediate the front face of the crystal and the array of photosensors.

17. The method of claim 11, wherein the gamma photons have an energy of about 511 keV.

18. The method of claim 11, wherein the gamma photons are generated during positron emission tomography.
